(19) United States
(12) Patent Application Publication
(10) Pub. No.: US 2019/0340195 A1
(43) Pub. Date: Nov. 7, 2019

(54) DYNAMICALLY DISPLAYING MEDIA FILES AT FUEL DISPENSERS

(71) Applicant: Maverik, Inc., Salt Lake City, UT (US)

(72) Inventors: Lance H. MORGAN, Perry, UT (US); Jason K. COPPIETERS, Brigham City, UT (US)

(21) Appl. No.: 16/516,108

(22) Filed: Jul. 18, 2019

Related U.S. Application Data
(63) Continuation-in-part of application No. 16/223,792, filed on Dec. 18, 2018.
(60) Provisional application No. 62/621,419, filed on Jan. 24, 2018.

(51) Int. Cl. G06F 16/438; G09G 5/36; G06Q 10/06

(52) U.S. Cl. CPC G06F 16/438; G09G 5/36; G09G 2370/20; G09G 2354/00; G06Q 10/0639

(57) ABSTRACT

Dynamically displaying media files at a fuel dispenser based on customer input. First, receiving a customer input including data identifying a customer and an indication of initiating a fuel transaction at a fuel dispenser. The data identifying the customer is then sent to an evaluation system. The evaluation system is associated with a database containing data related to multiple customers and configured to evaluate the customer data to generate customer evaluation data. When it is determined that a set of data related to the customer is contained in the database, the evaluation system is caused to retrieve a set of customer evaluation data related to the customer. The retrieved customer evaluation data is then used to determine a specific set of media files. The determined specific set of media files are then displayed at the fuel dispenser that the customer is using or is to use.

### CROSS-REFERENCE TO RELATED APPLICATIONS

This application is a continuation-in-part of U.S. patent application Ser. No. 16/223,792 filed on Dec. 18, 2018, entitled “INTERRUPTING A FUEL CONTROLLER”, which claims the benefit of and priority to U.S. Provisional Patent Application Ser. No. 62/621,419 filed on Jan. 24, 2018, and entitled “INTERRUPTING A FUEL CONTROLLER TO DYNAMICALLY CONTROL A FUEL DISPENSER,” all of which are expressly incorporated herein by reference.

### BACKGROUND

Fueling stations are ubiquitous. Every day, hundreds of millions of transactions occur at fueling stations across the world. When fueling stations were initially created, a human pump attendant would personally help each customer with the task of adding fuel to their vehicle. This process was necessary to both increase the safety of the fueling process as well as to help uneducated consumers with the fueling process. During these interactions, a fueling attendant might have a conversation with a driver and suggest other types of services offered at the fueling station.

Over time, fueling stations have become more and more automated. With the advent of credit card payments at a fueling dispenser, a customer can now complete the entire process of fueling their vehicle quickly and entirely at the dispenser itself. While this automation allows for greater efficiency for the fueling process, it may limit the exposure of the customer to other goods and services offered by the fueling station.

More recently, fuel dispensers have added digital displays that aid in the transaction process by allowing users to select options, provide identification information, or otherwise interact with the fuel dispenser to complete a fueling transaction. For instance, a display may ask if the user wants a car wash. In order to manage these sorts of interactions, most fueling stations incorporate a fuel controller that is programmed to interface with fuel dispensers to handle the automated transaction procedures. Often, the fueling station leases or otherwise procures a fuel controller and/or fuel dispensers from third parties because the manufacturers of fuel dispensers often implement proprietary protocols within the fuel dispensers to activate various functions of the dispensers. As such, a fuel controller may also be required to understand these protocols and to provide an interface between the fuel dispensers and other systems at the fueling station, such as point of sale systems inside a fueling station building at a convenience store, or transaction authorization/verification systems.

Further, recently, in addition to the simple display near the pin pad for users to swipe credit cards and interact with the POS system (and/or the fuel controller), in many gas stations, additional media devices or media players (e.g., larger LED monitors and/or speakers) are installed at the fuel dispenser to play media files to customers. For example, a video or audio advertisement may be played at the fuel dispenser.

It is common that these additional media devices or media players often play the same advertisement to each customer. Thus, different customers may be watching or listening to the same content regardless of whether they are interested in the content or not; additionally, a return customer may be listening to the same content repeatedly. Further, many gas stations media devices or media players are managed by third-party marketing companies to solicit advertisers. For example, once a gas station's media players are contracted to a marketing company, the gas station will no longer have control over the content played at those displays. The marketing company may put a competitor's advertisement at the gas station's displays. As a result, the business of the gas station itself may be damaged by the competitor's advertisement.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

Embodiments disclosed herein are related to computer systems, methods, and computer program products for dynamically displaying media files at fuel dispensers. The described embodiments enable dynamically displaying different media files to different customers when the corresponding customer starts fueling at the fuel dispenser.

The computer system may be a point of sale (POS) system that is configured to interact with a customer input device, a fuel controller, and one or more evaluation systems. The computer system receives a customer input including at least data identifying a customer and an indication of initiating a fuel transaction at a fuel dispenser. The computer system then sends at least a portion of the data identifying the customer to an evaluation system. The evaluation system is associated with a database that contains data related to multiple customers and is configured to evaluate the data related to the multiple customers to generate customer evaluation data.

The computer system further causes the evaluation system to determine whether any data related to the customer is contained in the database based on the received data identifying the customer. In response to a determination that a set of data related to the customer is contained in the database, the evaluation system is caused to retrieve a set of customer evaluation data related to the customer. The computer system then receives the set of customer evaluation data from the evaluation system. Based on the received set of customer evaluation data, the computer system determines a specific set of one or more media files that are to be displayed for the customer, and causes the determined specific set of one or more media files to be displayed at the fuel dispenser that the customer is at. The specific set of one or more media files may be selected from a predetermined set of a plurality of media files.

Accordingly, the principles described herein allow different sets of media files to be displayed to different customers based on the data related to the customers. For instance, certain media files may be tailored to a particular group of customers based on their purchase histories. As an example, if a customer has frequently purchased energy drinks, an advertisement related to energy drinks may be displayed to the customer. As another example, frequent customers may earn additional points, and sufficient points may allow a customer to receive special discounts or freebies. When a customer's points reach a threshold for receiving a freebie, a media file notifying or reminding the customer that a freebie is available may be displayed.

In some embodiments, in response to a determination that there is no data related to the customer is contained in the database, the computer system determines that a different set of one or more media files are to be displayed to the customer. The different set of one or more media files that are to be displayed to the customer is then displayed to the customer at the fuel dispenser. In some embodiments, the different set of one or more media files may be a set of randomly selected one or more media files.

In some embodiments, when the specific set of one or more media files includes multiple media files, the computer system further determines a sequence of the multiple media files that are to be displayed, and causes the multiple media files to be displayed in the determined sequence at the fuel dispenser.

In some embodiments, the computer system further receives an indication from a fuel controller that the fuel dispensing transaction is completed. The fuel controller is configured to control multiple fuel dispensers, including the fuel dispenser that the customer is at. After receiving the indication, the computer system sends information related to the completed fuel dispensing transaction to the evaluation system and causes the evaluation system to update the database based on the information related to the completed fuel dispensing transaction and to generate an updated set of evaluation data related to the customer.

In some embodiments, the computer system may have access to more than one evaluation systems, each of which may send the computer system a set of customer evaluation data, and the computer system may use the multiple set of customer evaluation data to determine multiple sets of media files that are to be displayed to the customer. The multiple sets of media files may then be caused to be displayed at a determined sequence at the fuel dispenser that the customer is at.

In some embodiments, the set of evaluation data received from a first evaluation system may be sent to a second evaluation system, and the second evaluation system may use both its own customer data and the first evaluation system's data to generate its evaluation data.

When the computer system receives an indication that the fuel transaction is completed, the computer system may send the information related to the completed fuel transaction to each of the multiple evaluation systems and update the corresponding evaluation data related to the customer.

In some embodiments, the evaluation system may be remote to the computer system and is accessible by the computer system via a global network. In some embodiments, the evaluation system may be local and coupled to the computer system.

In some embodiments, the customer input may include data identifying the customer's membership. The database associated with the evaluation system may include each of the multiple customers' membership information. The membership information may include a classification of each customer's membership or a point earned by each customer.

In some embodiments, the customer input may include credit card information (e.g., swiping a credit card). When the credit card is approved, the displaying of the specific set of one or more media files may be caused to start by the computer system.

In some embodiments, the displaying of the specific set of one or more media files may be caused to start by the fuel controller that is configured to control the fuel dispenser. In some embodiments, the displaying of the specific set of one or more media files may be caused to start when the customer starts pumping at the fuel dispenser. In some embodiments, the displaying of the specific set of one or more media files may be caused to start by an indication input by the customer.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1a illustrates an example fueling system in which the principles described herein may be implemented;

FIG. 1b is a functional diagram of an example fueling system that includes a default communication channel (which allows a fuel controller to take control of a display at the fuel dispenser during an uninterrupted state) and a bypass communication controller (which allows a point of sale (POS) system to control a display at the fuel dispenser during an interrupted state);

FIG. 2 illustrates an example embodiment allowing dynamically displaying media set based on customer input;

FIG. 3 illustrates an example embodiment of a POS system that is configured to dynamically determine media set based on customer evaluation data received from an evaluation system;

FIG. 4 illustrates an example embodiment of a POS system that is configured to dynamically determine media sets based on customer evaluation data received from multiple evaluation systems;

FIG. 5A illustrates a diagram of an example embodiment of a media specification control that is configured to determine a set of media files that are related to a customer's different loyalty level;

FIG. 5B illustrates a diagram of an example embodiment of a media specification control that is configured to determine a set of media files that are related to the loyalty benefits a customer may qualify;

FIG. 5C illustrates a diagram of an example embodiment of a media specification control that is configured to determine a set of media files based on a predetermined sequence to avoid inter-repeat;

FIG. 5D illustrates a diagram of an example embodiment of a media specification control that is configured to determine a set of media files using a randomizer to avoid inter-repeat;

FIG. 5E illustrates an example table including predetermined rules that may be implemented at a media specification control to determine a different set of media files for a different customer;

FIG. 6 illustrates a diagram of example communications that may occur amongst different devices during a customer transaction at a fuel dispenser;

FIG. 7 illustrates a flowchart of an example method for dynamically displaying media files at a fuel dispenser;

FIG. 8 illustrates an example of a computer system that may be used to employ embodiments described herein.

### DETAILED DESCRIPTION

Embodiments disclosed herein are related to computer systems, methods, and computer program products for dynamically displaying media files at fuel dispensers. The described embodiments enable dynamically displaying different media files to different customers when the corresponding customer starts fueling at the fuel dispenser.

The computer system may be a point of sale (POS) system that is configured to interact with a customer input device, a fuel controller, and one or more evaluation systems. The computer system receives a customer input including at least data identifying a customer and an indication of initiating a fuel transaction at a fuel dispenser. The computer system then sends at least a portion of the data identifying the customer to an evaluation system. The evaluation system is associated with a database that contains data related to multiple customers and is configured to evaluate the data related to the multiple customers to generate customer evaluation data.

The computer system further causes the evaluation system to determine whether any data related to the customer is contained in the database based on the received data identifying the customer. In response to a determination that a set of data related to the customer is contained in the database, the evaluation system is caused to retrieve a set of customer evaluation data related to the customer. The computer system then receives the set of customer evaluation data from the evaluation system. Based on the received set of customer evaluation data, the computer system determines a specific set of one or more media files that are to be displayed for the customer, and causes the determined specific set of one or more media files to be displayed at the fuel dispenser that the customer is at. The specific set of one or more media files may be selected from a predetermined set of plurality of media files.

Accordingly, the principles described herein allow different sets of media files to be displayed to different customers based on the data related to the customers. For instance, certain media files may be tailored to a particular group of customers based on their purchase histories. As an example, if a customer has frequently purchased energy drinks, an advertisement related to energy drinks may be displayed to the customer. As another example, frequent customers may earn additional points, and sufficient points may allow a customer to receive special discounts or freebies. When a customer's points reach a threshold for receiving a freebie, a media file notifying or reminding the customer that a freebie is available may be displayed.

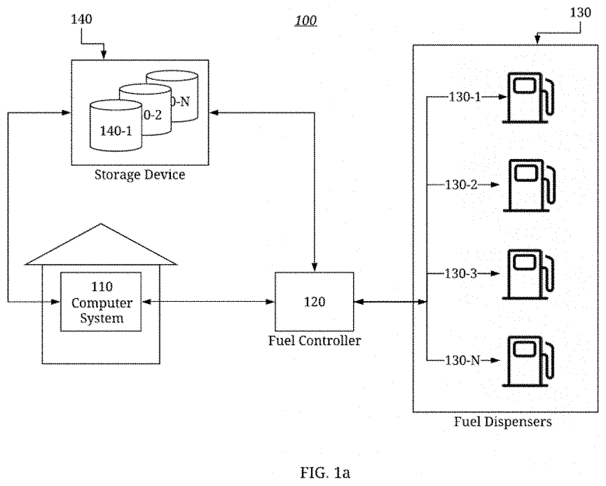

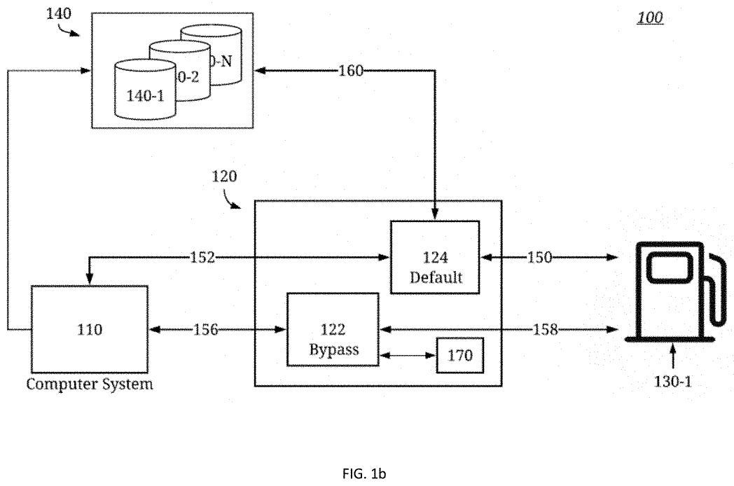

Because the principles described herein may be performed in the context of a gas station with multiple fuel dispensers, each of which is controlled by a fuel controller, an example fuel dispensing system will be described with respect to FIGS. 1a and 1b. Then, this description will return to the principles of dynamically displaying media files at a fuel dispenser based on customer input with respect to the remaining figures.

FIG. 1a illustrates an example of a fuel dispensing system 100 that includes a computer system 110 operated from within a fueling station building (e.g., inside a convenience store, for example.) For example, computer system 110 may be a point of sale (POS) system used to manage and track all transactions occurring at the fueling station including both fuel dispensing transactions occurring at the fuel dispensers 130 outside of the fueling station building, as well as any transactions that occur within the fueling station building (e.g., food and beverage sales.)

The computer system 110 is connected to a fuel controller 120 and computer storage 140. Computer storage 140, as illustrated, includes storage device 140-1, storage device 140-2, and storage device 140-N. It is appreciated that storage 140 may include any number of storage devices and that, as illustrated, storage devices 140-1, 140-2, and 140-N are included merely to illustrate the fact that computer system 110 may be connected to a single storage device or multiple storage devices.

In one embodiment, computer system 110 connects to storage 140 over a network or other remote communication protocol, while in other embodiments, storage 140 is local storage or even integrated within computer system 110. Accordingly, the computer system 110 has access to information storage, such as storage 140, and can communicate with storage 140 in a manner that allows information to be stored at storage 140 and/or retrieved from storage 140. It should also be appreciated that in some embodiments, computer systems other than computer system 110 can access storage 140. In some embodiments, storage system 140 is a remote storage array that includes individual storage devices 140-1, 140-2, and 140-N. In such scenarios, computer system 110 can access at least one of the individual storage devices. In some scenarios, other computer systems can access storage 140 and the various individual storage devices contained therein.

In some embodiments, storage 140 includes multiple different physical storage arrays. For example, storage 140 may include multiple physical storage devices located in different locations and accessible by the various devices within system 100 over a different network. As such, while illustrated as a single storage 140 within FIG. 1a, it should be appreciated that, for example, each individual storage device 140-1, 140-2, and/or 140-N may be implemented individually and discretely from one or all of the other individual storage devices.

As noted, FIG. 1a also includes fuel controller 120. Fuel controller 120 is connected to computer system 110 by any suitable communications means. Such communication means allows for two-way communication between fuel controller 120 and computer system 110. In some embodiments, communication is provided by through a physical connection such as a by cabling, while in other embodiments wireless communication is additionally or alternatively utilized. Further, the particular communications protocol utilized to allow communications between computer system 110 and fuel controller 120 is not important to the present invention. Rather, the present invention requires only that some form of two-way communication is enabled between fuel controller 120 and computer system 110.

In some embodiments, fuel controller 120 is also connected to fuel dispensers 130. As illustrated, fuel dispensers 130 include individual fuel dispensers 130-1, 130-2, 130-3, and 130-N. It should be appreciated that in other embodiments, fuel dispensers 130 includes a single fuel dispenser, while in other embodiments, fuel dispensers 130 include more than the four illustrated dispensers. In some embodiments, fuel dispenser 130 may include 5, 10, 20, or “N” fuel dispensers as denoted by individual fuel dispenser 130-N.

Fuel controller 120, then, is connected to the individual fuel dispensers within fuel dispenser 130 by any suitable means that allows for two-way communication between fuel controller 120 and individual fuel dispensers. In some embodiments, communication is provided through a physical connection such as a by cabling between fuel controller 120 and each individual fuel dispenser, while in other embodiments wireless communication is additionally or alternatively utilized. Further, the particular communications protocol utilized to allow communications between fuel controller 120 and the various individual fuel dispensers is not important to the present invention. Rather, the present invention requires only that some form of two-way communication is enabled between fuel controller 120 and fuel dispensers 130.

In some embodiments, fuel controller 120 is also connected to storage 140, including one or more of individual storage devices 140-1 through 140-N. In some embodiments, fuel controller 120 can access the individual storage device(s) that computer system 110 can access. In other embodiments, storage 140 includes individual storage devices dedicated to communication with fuel controller 120.

Turning now to FIG. 1b, a more detailed illustration of a fuel dispensing system 100 is shown. In the illustrated embodiment, system 100 includes a computer system 110 such as the computer system 110 shown in conjunction with FIG. 1a. FIG. 1b also illustrates individual storage devices 140-1, 140-2, and 140-N, such as the storage devices illustrated in FIG. 1a. It should be appreciated that while in some embodiments computer system 110, as shown in B, is the same as computer system 110 of FIG. 1a, in other embodiments, computer system 110 of FIG. 1b differs from the system of FIG. 1a.

The embodiment of FIG. 1b also illustrates a fuel controller 120 that includes a default communication controller 124 and a bypass communication controller 122. Notably, both communication controllers are communicatively connected to computer system 110 through communication channel 152 (with regard to default communication controller 124) and through the communication channel 156 (with regard to bypass communication controller 122.) Likewise, the default communication controller 122 is communicatively connected to a fuel dispenser (e.g., any of the fuel dispensers 130 illustrated in FIG. 1a) over communication channel 150 while bypass communication controller 122 is configured to communicate over communication channel 158.

While communication channels 150, 152, 156, and 158 are illustrated as separate communication channels, it should be appreciated that fuel controller 120 can communicate with computer system 110 and the various fuel dispensers over these or other communication channels. Additionally, in some embodiments, the separately shown communication channels may be combined to function over a single physical or wireless communication channel. In other words, for some embodiments, the individual communication channels illustrated in FIG. 1 are abstract representations of the concept that various sub-controllers within a fuel controller, such as 120, are capable of communicating with other portions of system 100.

As illustrated, each of the communication channels within system 100 enables two-way communication between the various connected communicative devices. While system 100 illustrates two-way communication for all communication channels, it should be appreciated that in practice, some of the various communication channels may implement to allow only one-way communications.

Returning to fuel controller 120, two sub-controllers are illustrated. Default communication controller 124 is configured to handle communications between a fuel dispenser and computer system 110 while fuel controller 120 is in a default or “uninterrupted” state. For example, prior to commencing a dispensing transaction, a fuel dispenser, such as fuel dispenser 130-1, is configured to display a default interface at a digital display integrated within the fuel dispenser. In some embodiments, the default interface may include a generic “welcome” message, or include default branding content (e.g., a logo or a slogan identifying the fueling station.)

In some embodiments, this default information is presented at the fuel dispenser based on the fuel controller being pre-programmed to display default content. For example, prior to commencement of a transaction, default communication controller 124 of fuel controller 120 transmits default content to fuel dispenser 130-1 for display at a digital display of the fuel dispenser.

In some embodiments, fuel controller 120 is pre-programmed with the particular content that will be displayed using default controller 124. For example, fuel controller 120 may include internal storage where content can be stored and retrieved. In other embodiments, fuel controller 120 may retrieve default display information over communication channel 160 from a remote storage device such as storage device 140-2. Upon retrieval of default information, fuel controller 120 utilizes default communication controller 124 to transmit the default information over communication channel 150 for display at fuel dispenser 130-1.

Next, upon commencing a fueling transaction at fuel dispenser 130-1, a user provides information at the fuel dispenser 130-1. For example, in response to a default display message sent by default communication controller 124, a user provides a payment method such as a credit card by swiping the credit card at fuel dispenser 130-1. Upon receiving the user input, fuel dispenser 130-1 transmits the input over communication channel 150 back to default communication controller 124 of fuel controller 120. In some embodiments, fuel controller 120 then transmits the user input over communication channel 152 from default communication controller 124 to computer system 110. For example, the user input may be transmitted to computer system 110 in order to authorize the payment method.

Upon performing whatever task is necessary with the information received from fuel controller 120, in some embodiments, computer system 110 then transmits information back to default communication controller 124 of fuel controller 120 over communication channel 152. For example, computer system 110 transmits an indication that the transaction has been authorized to fuel controller 120. As a result, default communication controller 124 then authorizes fuel dispenser 130-1 to dispense fuel to the customer.

In some embodiments, upon receiving the information from the computer system 110, default communication controller 124 transmits different default content to fuel dispenser 130-1 that is relevant to the new status of the transaction. For example, after receiving an authorization indication from the computer system 110, default communication controller 124 transmits new default content prompting the user to select a fuel grade for dispensing.

In some embodiments, the result of receiving the new user input at the fuel dispenser 130-1 is to repeat the sequence described above that occurred as the result of receiving the initial user input. In other embodiments, some communications do not involve one or more of the computer system 110, fuel controller 120, or fuel dispenser 130-1. For example, in some embodiments, once a first user input is processed by computer system 110 (e.g., a credit card authorization), subsequent communications relating to the authorized transaction occur only between the fuel controller 120 and the authorized fuel dispenser such as fuel dispenser 130-1. It should be appreciated that in some transactions, a mix of communication transmission occurs in such a manner that some involve a full round-trip communication such as the one described above in conjunction with the first user input, while other communications occur without one or more of the described components being involved.

As illustrated above, each of the steps described with respect to the uninterrupted state occurs based on a protocol preconfigured and controlled by fuel controller 120. It is particularly noted that the content communicated to fuel dispenser 130-1 at each step of an uninterrupted-state transaction includes only content preconfigured to be transmitted by the fuel controller 120 based on the transaction sequence currently being processed.

For example, in some embodiments, fuel controller 120 presents default content at the display of fuel dispenser 130-1. Based on receiving user input initiating a fueling event (e.g., swiping a credit card), fuel controller 120 passes the received input to computer system 120 for authorization. Once authorized, fuel controller 120 presents a second default content at fuel dispenser 130-1 instructing the user to select a grade of fuel for dispensing. Next, the user selects a fuel and begins dispensing the fuel. During fuel dispensing, fuel controller 120 maintains two-way communication with fuel dispenser 130-1 to, for example, monitor the amount of fuel being dispensed. Upon completion of dispensing fuel, the user then sends an indication that fueling has completed (e.g., places the fuel hose back in the fuel dispenser holder.) Fuel dispenser 130-1 then transmits an indication to fuel controller 124, indicating that the user has finished dispensing fuel. It should be noted that during fueling, the fuel dispenser communicates various content to the fuel dispenser without interaction from the computer system 110. However, upon completion of the fueling process, fuel controller 120 then again communicates to computer system 110, including providing various information such as the total amount of fuel dispensed so that the user can be charged according to the authorized payment method.

The default transaction processing protocol and communications sequences described above are intended to illustrate the “default” protocols that are commonly preprogrammed within the logic of a fuel controller, such as fuel controller 120. The default process occurs while the fuel controller is in an “uninterrupted state.” As such, it should be appreciated that the terms default and uninterrupted, when used in association with the status of a fuel controller can be used interchangeably unless otherwise indicated.

Returning to FIG. 1b, the principles described herein further discloses that the fuel controller 120 may also include a bypass communication controller 122 that is connected to computer system 110 over communication channel 156 and is also connected to a fuel dispenser, such as fuel dispenser 130-1, over communication channel 158. In some embodiments, the bypass communication controller 122 is implemented within fuel dispenser 120 by means of software or logic. In other embodiments, the bypass communication controller 122 is implemented within the hardware of fuel controller 120 such that communications occur using communication channels managed by a hardware controller. However, within the parameters of the present invention, various methods of implementing bypass communication controller 122 within fuel controller 120 may be employed.

Thus, the present invention contemplates only that certain communications are handled by fuel controller 120 according to a bypass or “interrupted” protocol (e.g., such as when communications are transmitted through bypass communication controller 122) or according to a default or “uninterrupted” protocol (e.g., such as when transmitted through default communications protocol 124.)

It should also be noted that in some embodiments, such as system 100, bypass communication controller 122 is not directly connected to storage 140. This may be important because the function of bypass communication controller 122 is to allow computer system 110 to dictate the content passed by fuel controller 120 to a fuel dispenser. Bypass communication controller 122 functions by allowing computer system 110 to bypass, or otherwise circumvent, the default protocols preprogrammed within fuel controller 120. As has been discussed previously, the ability of computer system 110 to utilize bypass communication controller 122 rests in the ability of computer system 110 to generate and transmit a signal to fuel controller 120 that places it in an “interrupted state.” While operating within an interrupted state, fuel controller 120 ceases executing at least some of its default or preprogrammed functions instead of relying on computer system 110 to dictate at least some of the operations.

In other embodiments, bypass communication controller 122 is connected to a storage device, such as data storage 140. In such scenarios, this connection is provided only to allow bypass communication controller 122 to access certain data at the command of computer system 110. For example, in some embodiments, computer system 110 provides content directly to bypass communication controller 122 that is then caused to be presented at fuel controller 130-1. However, in other embodiments, computer system 110 directs bypass communication controller 122 to retrieve or otherwise access the desired content from data storage 140 that is then caused to be displayed on fuel controller 130-1. In such embodiments, while bypass communication controller 122 can be connected to data storage 140, bypass communication controller 122 only communicates with the storage device at the behest of computer system 110 while fuel controller 120 is operating in an interrupted mode.

For the sake of completeness, in another embodiment, fuel controller 120 includes local storage 170. Within this local storage, various content elements and data are stored. For example, a library of pre-generated custom screen templates is stored within internal storage 170. In such embodiments, computer system 110 communicates with bypass communication controller 122 to provide an indication of a particular content element or data that should be retrieved from fuel controller internal storage 170. Bypass communication controller 122 then accesses internal storage 170 to retrieve the identified data and then causes the data to be transmitted to fuel dispenser 130-1 over communication channel 158.

In another embodiment, internal storage 170 is stored within fuel dispenser 130-1 instead of within fuel controller 120. In that embodiment, computer system 110 directs bypass communication controller 122 over communication channel 156 to retrieve the indicated content from local storage 170. However, because local storage 170 is now stored at fuel controller 130, bypass communication controller requests the identified data from fuel controller 130-1 over communication channel 158 and causes the data to be displayed at fuel controller 130-1. Thus, it should be appreciated that depending on the embodiment, content identified by computer system 110 for display at fuel controller 130-1 is retrieved from external storage, such as data storage 140, storage contained directly within computing device 110, storage contained directly within fuel controller 120, or storage contained directly within fuel dispenser 130-1.

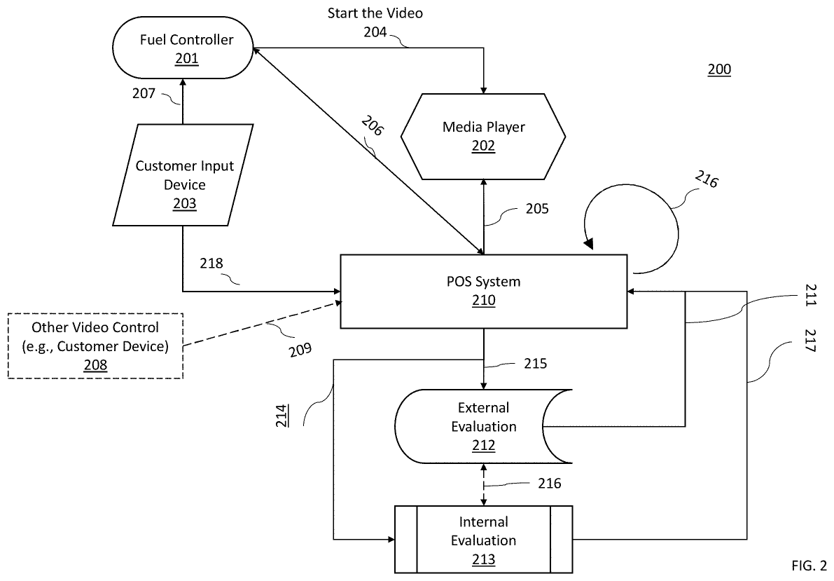

As described above with respect to FIGS. 1a and 1b, the display (or any other media player) coupled to the fuel dispenser 130-1 may be controlled by the fuel controller 120 directly via the default communication channel 124 or by the computer system 110 via the bypass communication channel controller 122. Alternatively, or in addition, the display (or any other media player) may also be controlled by the computer system 110 directly without having to communicate through the fuel controller 120. Further, the display described with respect to FIGS. 1a and 1b may be a display coupled to a credit card machine or a pin pad. Alternatively, or in addition, the display described with respect to FIGS. 1a and 1b may be an LED display that is separate or independent from the credit card machine or the pin pad. Such displays coupled to the credit card machine, LED displays that is separate or independent from the credit card machine, speakers, and/or a combination thereof are herein after also referred to as media players. The principles described herein allow dynamically generating media files that fit to any one of the media players placed at or near each fuel dispenser based on the received customer information. Further details of dynamically generating and displaying media files based on customer input are described with respect of FIGS. 2 through 7 below.

FIG. 2 illustrates an example embodiment of a system 200 for dynamically displaying media files to customers. The system 200 includes at least a fuel controller 201, a media player 202, a customer input device 203, and a point of sale (POS) system 210. The fuel controller 201 may correspond to the fuel controller 120 of FIGS. 1a and 1b. The fuel controller 201 is configured to control one or more fuel dispensers (not shown) including the fuel dispenser that the customer is to use. The customer input device 203 may be any customer input device, including (but are not limited to) a credit card input device including a pin pad at the fuel dispenser, a register inside the store of the gas station, and a customer's mobile device (e.g., mobile app). The media player 202 may include, but are not limited to, a display or a speaker, or a combination thereof. The media player 202 may be placed near or coupled to the fuel dispenser (not shown) or the customer input device 202 (e.g., the credit card machine).

When a customer comes to a fuel pump at a gas station, the customer often swipes his/her credit card at the fuel pump or at the register inside the convenient store of the gas station. In some embodiments, the customer input device 203 may transmit the customer information, including the credit card information to the fuel controller 201, which is represented by the arrow 207. The fuel controller 201 may then pass on the credit card information to the POS system 210, which is represented by the arrow 206.

In some embodiments, the customer input device 203 may transmit the customer information directly to the POS system 210, which is represented by arrow 218. For example, the customer input device 203 may be the customer's mobile phone, and the mobile phone may transmit all the necessary information including the credit card information to the POS system via the Internet without going through the fuel controller 201.

Further, the POS system 210 has access to one or more evaluation systems. As illustrated in FIG. 2, the POS system 210 has access to an internal evaluation system 213 and/or an external evaluation system 212. The internal evaluation system 213 may have access to a data storage that stores customer data collected based on the customer's past fuel transactions and gas station convenient store purchase transactions. The internal evaluation system 213 is further configured to evaluate the customer data to generate internal “customer evaluation data.”

For example, many gas companies have one or more loyalty programs. The internal evaluation system 213 may evaluate the customer's past purchase transaction history to determine and record each customer's loyalty level. The internal evaluation system 213 may classify customers into different groups based on the customer's past purchase transaction history (e.g., platinum member group, gold member group, silver member group, etc.). In such a case, the customer evaluation data may include data related to the classified group information of each customer. As another example, the internal evaluation system 213 may evaluate the customer data to generate award points to each customer member, and the customer evaluation data may include the award points of each customer.

Some loyalty programs provide customers a membership number and/or a membership card. In some embodiments, the customer input may include membership information. The customer may scan his/her customer membership card or enter the customer's membership number or other membership identifiers at the customer input device 203. Based on the entered customer membership number and/or other membership identifiers, the internal evaluation system 213 may retrieve the internal evaluation data related to the customer from the customer database.

Unlike the internal evaluation system 213, the external evaluation system 212 may have access to an external data storage that stores customer data collected by a third party (which may not be related to the customer's fuel transactions or gas station convenient store purchase transactions). The external evaluation system 212 may then evaluate the external customer data to generate external customer evaluation data, which is different from the internal customer evaluation data. For example, the external evaluation system 212 may be a credit card company's system. The credit card company's system may evaluate the credit purchase history of the customers to classify the customers into different groups or classifications. The generated different customer evaluation data may include the group or classification information related to each customer based on the corresponding customer's purchase history, including purchase transactions occurred outside of the affiliated gas stations.

As such, the database of the internal evaluation system 213 and the database of the external evaluation system 212 may include data related to different sets of customers, but the different sets of customers may overlap at least partially.

After receiving the customer data entered at the customer input device 203, the POS system 210 then passes at least a portion of the customer data to the internal evaluation system 213 and/or the external evaluation system 212, which are represented by the arrows 214 and 215. Each of the internal evaluation system 213 and/or the external evaluation system 212 then determines whether its respective database includes any data related to the customer based on the received customer identification information (e.g., membership number or credit card number). If it is determined that the respective database includes a set of data related to the customer, the corresponding evaluation system retrieves the corresponding customer evaluation data from the corresponding data storage, and send the retrieved evaluation data to the POS system 210, which are represented by arrows 211 and 217. On the other hand, if it is determined that no data related to the customer is stored at the respective database, the corresponding evaluation system 212 or 213 may notify the POS system such a determination, which may also be represented by arrows 211 and 217.

Furthermore, in some embodiments, the external evaluation system 212 may first send the external customer data (and/or the external evaluation data) to the internal evaluation system 213, which is represented by the arrow 216. The internal evaluation system 213 then evaluates both the external customer data (and/or external evaluation data) and the internal customer data to generate the internal evaluation data.

Similarly, in some embodiments, the internal evaluation system 213 may also send the internal customer data (and/or the internal evaluation data) to the external evaluation system 212, which is also represented by the arrow 216. The external evaluation system 212 may also evaluate both the external and internal customer data (and/or internal evaluation data) to generate the external customer evaluation data.

The bi-directional dotted arrow 216 represents that the internal and external evaluation systems 213 and 212 may or may not send the customer data and/or customer evaluation data to each other. However, it is not necessary that the communication is always two ways. In some embodiments, the data may be sent from the external evaluation system 212 to the internal evaluation system 213; and in some embodiments, the data may be sent from the internal evaluation system 213 to the external evaluation system 212. In some embodiments, there may not be any direct communication between the internal and external evaluation systems 213 and 212.

After the POS system 210 receives the internal and/or external customer evaluation data, the POS system 210 then determines a specific set of one or more media files that are to be displayed to the customer based on the customer evaluation data, which is represented by the arrow 216. The POS system 210 then causes the determined specific set of one or more media files to be displayed at the media player 202, which is represented by arrow 205.

The specific set of one or more media files may be selected from a predetermined pool of media files. In some embodiments, the predetermined pool of media files may be stored at the POS system 210. In some embodiments, the predetermined pool of media files may be stored at a remote server (not shown). In some embodiments, the predetermined pool of media files may also be stored at the fuel controller 201, the fuel dispenser (not shown), and/or the media player 202.

When the pool of media files are not stored at the media player 202, the POS system 210 may cause the specific set of media files to be sent to the media player 202. When the pool of media files are stored at the media player 202, the POS system 210 may send to the media player 202 an identifier, file name, and/or address of each of the specific set of one or more media files, so that the media player 202 can retrieve the determined specific set of one or more media files from its local storage.

In some embodiments, the displaying of the specific set of one or more media files may be caused to start via the fuel controller 201, which is represented by the arrow 204. For example, when a customer swipes his/her credit card at the fuel dispenser, the credit card information may be sent to the fuel controller 201. The fuel controller 201 may pass on the credit card information to the POS system 210, and the POS system 210 may then cause the credit card information to be processed via a payment processing system. If the credit card is approved, the POS system 210 may notify the fuel controller 201 the approval, which may then cause the fuel controller 201 to turn on the pump of the fuel dispenser, and at the same time, to cause the specific set of one or more media files to start to play at the media player 202.

In some embodiments, the displaying of the specific set of one or more media files may be caused to start via the POS system 210 directly. For example, when the credit card is approved, the POS system 210 may directly cause the specific set of one or more media files to start at the media player 202. In some embodiments, when the media files are not stored at the media player 202, the POS system 210 may cause the specific set of media files to be sent to the media player 202 and cause the media files to be displayed at the media player 202 once media files are received by the media player 202.

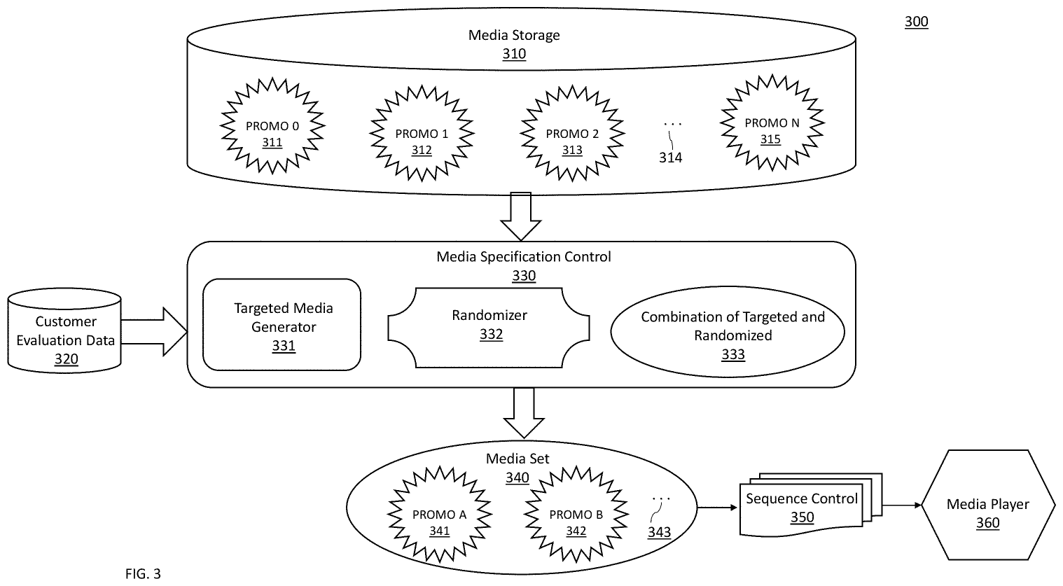

As described above, the POS system 210 determines the specific set of media files that are to be displayed at fuel dispenser based on the customer evaluation data retrieved from the internal and/or external evaluation system(s). The details of how the POS system 210 determines each specific set of media files are further described with respect to FIGS. 3 through 5E.

FIG. 3 illustrates an example embodiment of the POS system 300 that is configured to dynamically determine a media set based on customer evaluation data received from an evaluation system. The POS system 300 may correspond to the POS system 210 of FIG. 2 and/or the computer system 110 of FIGS. 1a and 1b.

Referring to FIG. 3, the POS system 300 may include a media storage 310, a media specification control 330, and a sequence control 350. The media storage 310 stores multiple promotional media files (e.g., promo media 0 file 311, promo media 1 file 312, promo media 2 file 313, . . . , and promo media file N 315). The ellipsis 314 represents that there may be any number N of promo media included in the media storage 310. N is a natural number. The media specification control 330 is configured to determine a specific set of media 340 to be displayed to a customer. The determined specific set of media files 340 may be sent to a sequence control 350 to determine a sequence of the set of media files 340. The set of media files 340 may then be caused to be displayed in the determined sequence at the media player 360, which is next to the fuel dispenser that the customer is using or to use.

As illustrated in FIG. 3, the media specification control 330 receives customer evaluation data 320 from an evaluation system (not shown), which may correspond to the internal evaluation system 213 or the external evaluation system 212 of FIG. 2. Based on the received evaluation data 330, the media specification central 330 may implement one or more different methods to determine the specific set of media files 340. In particular, a targeted media generator 331 may be implemented in the media specification control 330 to generate targeted media sets based on the customer evaluation data 320. Alternatively, a randomizer 330 may be implemented in the media specification control 330 to randomly generate media sets. Alternatively, or in addition, a combination of targeted media generator and a randomizer may be implemented, which is represented by the block 333.

The generated media set 340 may include promo media A file 341 and promo media B file 342, each of which is a media file included in the pool of promo media files 310. The ellipsis 343 represents that there may be any number of promo media files included in the specific set of media files 340.

If the specific set of one or more media files 340 includes more than one media file, the POS system 300 may further be configured to determine a sequence of the media files 340 to be displayed. For example, the set of media files 340 may be sent to a sequence control 350 to determine a sequence, in which the set of media is to be displayed. Thereafter, the set of media 340 may then be sent to the media player 360 at the fuel dispenser and be displayed at the media player 360 in the determined sequence.

Even though in the embodiment illustrated in FIG. 3, the media storage 310 storing the pool of the promotional media files 311 through 315 is a component of the POS system, as briefly discussed above, the promotional media files 311 through 315 are not required to be stored locally at the POS system 300. In some embodiments, the multiple media files 311 through 315 may be stored at a remote storage that is accessible by the POS system 300. In some embodiments, the multiple media files 311 through 315 may be stored at the media player 360, at the fuel dispenser, and/or at the fuel controller.

In some embodiments, the POS system 300 may merely store locally the names, addresses and/or URLs of the remotely stored media files 311 through 315. Once the set of media 340 and the sequence of the set of media files are determined, the POS system 300 may cause the remotely stored media files to be sent to the media player 360 directly from the remote storage. Alternatively, if the media files 311 through 315 are stored at the media player 360 or the fuel dispenser, the POS system 300 may determine and send the sequence of the address of the media files (and/or the name of the media files) to the display to cause the set of media files to be displayed in the determined sequence.

In some embodiments, the multiple media files 311 through 315 may be stored at both a remote storage, the media player 360 and/or the POS system 300. The remote storage may be configured to update the media stored at the media player 360 and/or the POS system 300 periodically or manually. As such, it is easy for the fueling company to add to or delete media files in the pool of media files 310.

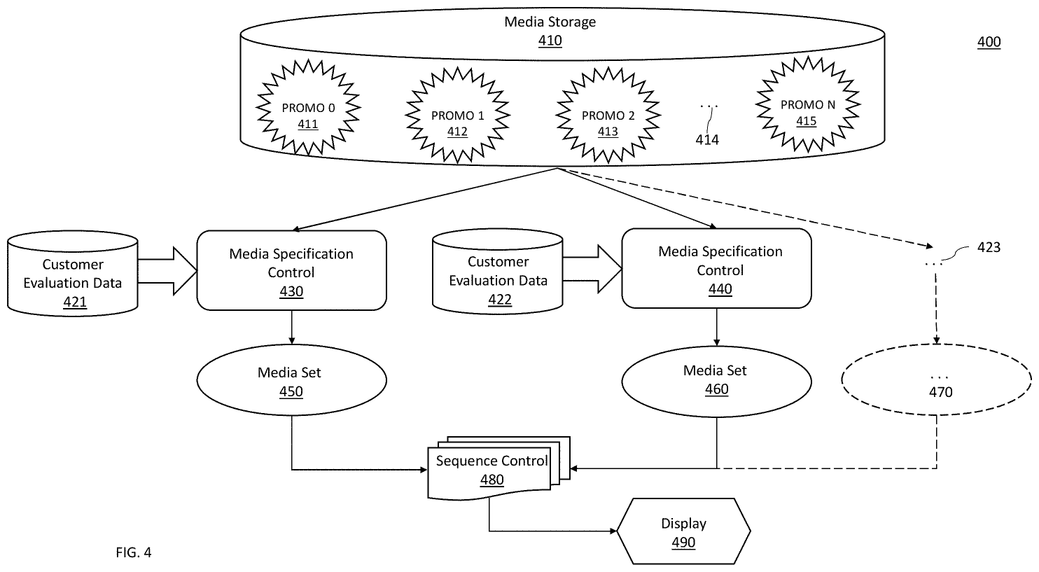

FIG. 4 illustrates another example embodiment of the POS system 400 that is configured to dynamically determine multiple sets of media files 450, 460, and 470 based on customer evaluation data 421 and 422 generated by multiple evaluation systems. The POS system 400 may also correspond to the POS system 210 of FIG. 2 and the computer system 110 of FIGS. 1a and 1b.

As illustrated in FIG. 4, the POS system 400 includes a media storage 410, multiple media specification controls 430 and 440, and a sequence control 480. The ellipsis 423 represents that there may be any number of multiple media specification controls implemented at the POS system 400. The media storage 410 may correspond to the media storage 310 of FIG. 3.

Each of the media specification controls 430 and 440 receives a respective set of customer evaluation data 421 and 422. For example, the media specification control 430 may receive the customer evaluation data set 421 from the internal evaluation system 213; and the media specification control 430 may receive the customer evaluation data set 422 from the external evaluation system 212. It is not limited that only one internal evaluation system 213 and one external evaluation system 212 may be implemented. There may be multiple internal evaluation systems and/or multiple external evaluation systems implemented to supply customer evaluation data to the POS system 400.

As illustrated in FIG. 4, the media specification control 430 receives a first set of customer evaluation data 421 from a first customer evaluation system (not shown). Based on the received first set of customer evaluation data 421, the media specification control 430 determines a first set of media files 450 that will be displayed to the customer. On the other side, the media specification control 440 receives a second customer evaluation data 422 from a second customer evaluation system (not shown). Based on the received second set of customer evaluation data 422, the media specification control 440 determines a second set of media files 460 that will be displayed to the customer. The ellipsis 470 represents that there may be any number set of media determined by any number of media specification controls.

The determined first set of media files 450 and the second set of media files 460 are then sent to the sequence control 480. The sequence control 480 determines a sequence in which the two sets of media files 450 and 460 are to be displayed. The two sets of media files 450 and 460 are then caused to be displayed at the media player 490.

The media storage 410 is similar to the media storage 310 of FIG. 3. As such, the media storage 410 is not necessary a local storage related to the POS system 400. The media storage 410 may be a remote storage or a storage stored at the media player 490, at the fuel dispenser, or at the fuel controller.

Even though as illustrated in FIG. 4, each set of customer evaluation data 421, 422 is sent to a separate media specification control 430, 440, it is not required to have a separate media specification control for each set of customer evaluation data. In some embodiments, multiple set of customer evaluation data 421 and 422 may be sent to one single media specification control, and the single media specification control may evaluate more than one set of the customer evaluation data 421 and 422 altogether to determine a single set of media files. The single set of media files may then be sent to the sequence control 480.

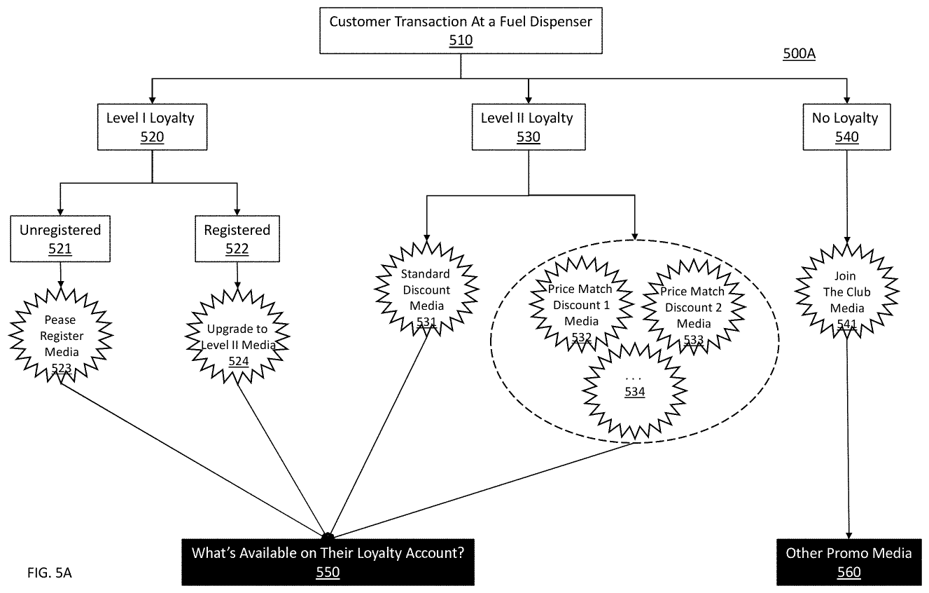

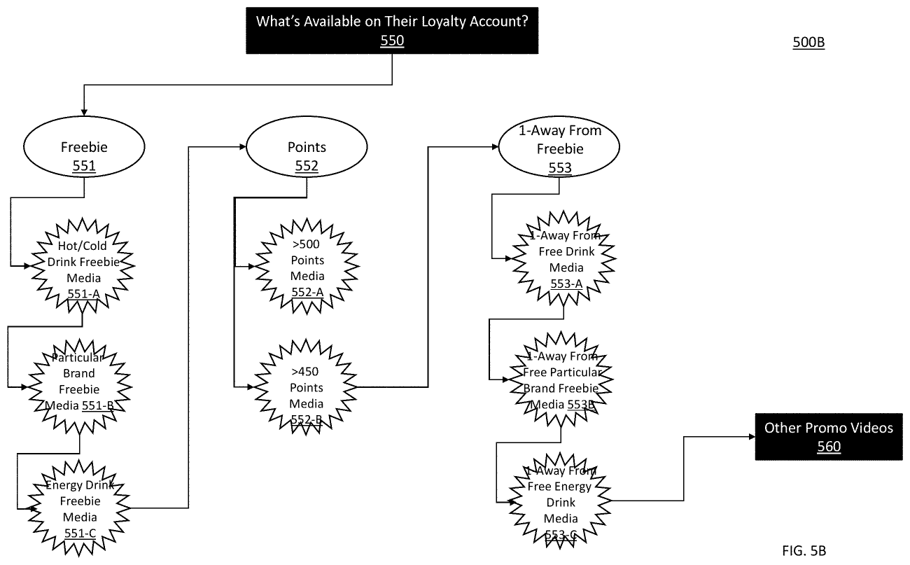

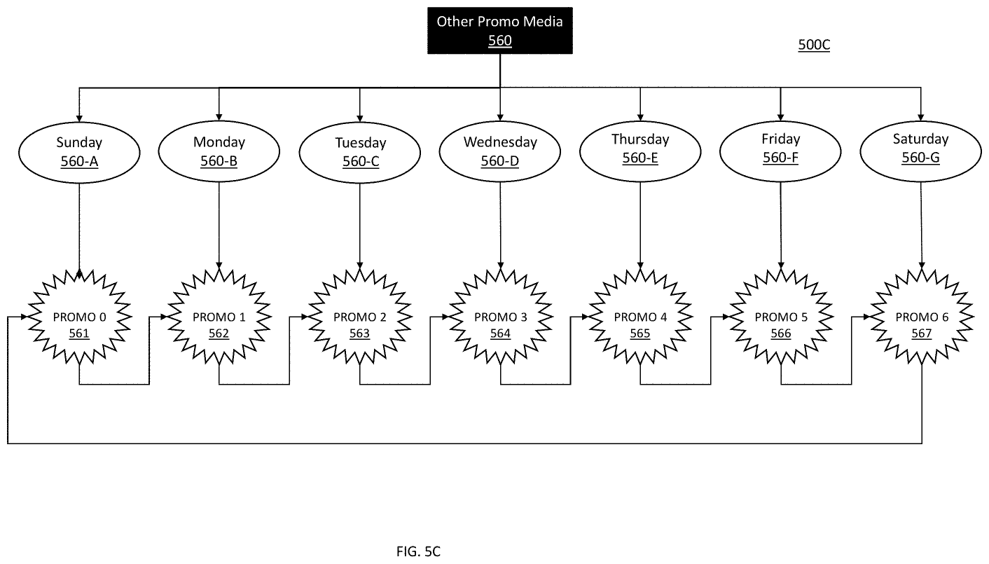

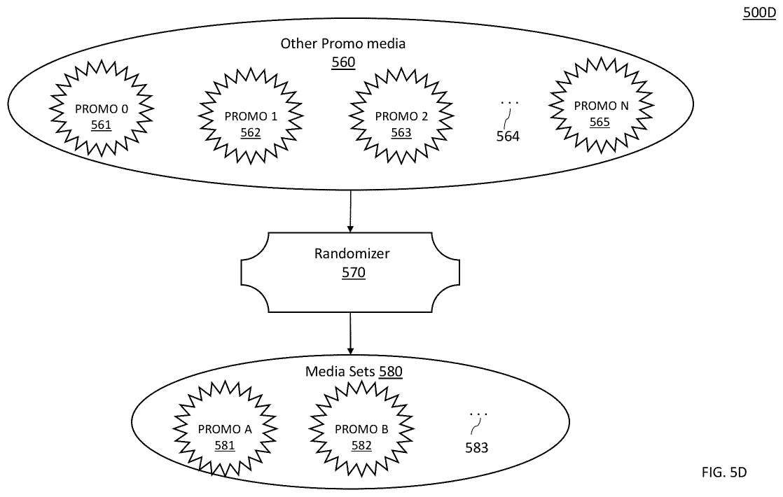

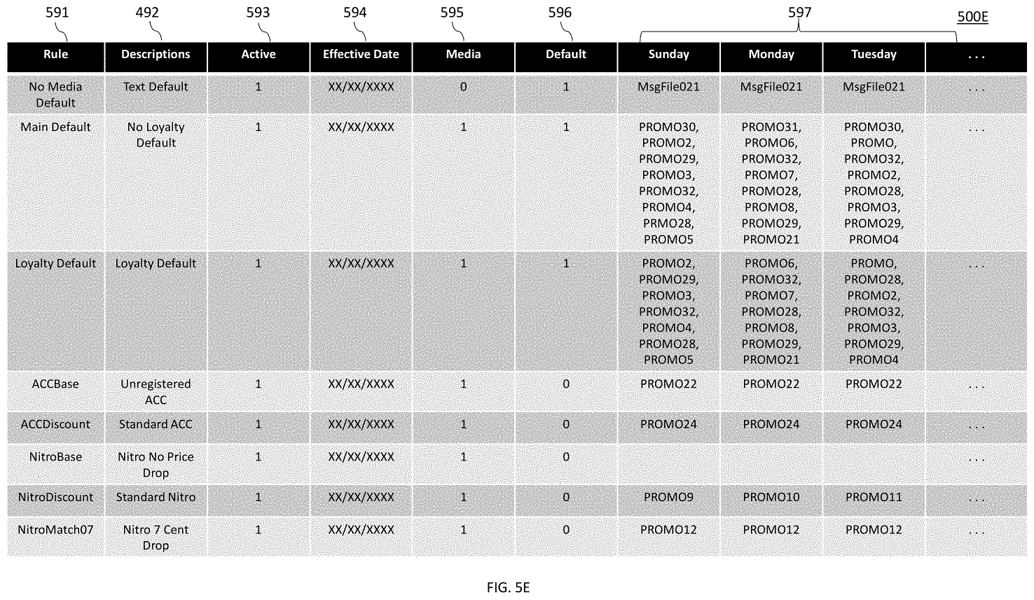

FIG. 5A further illustrates an example embodiment 500A of a media specification control that is configured to determine media files based on customer evaluation data generated by an evaluation system. The media specific control may correspond to the media specification control 330 of FIG. 3, and/or 430, 440 of FIG. 4. The media specification control illustrated in FIG. 5A may receive customer evaluation data generated by an example internal evaluation system (not shown). As illustrated in FIG. 5A, block 510 represents that a customer has initiated a transaction at a fuel dispenser. The internal evaluation system receives customer information from the POS system and retrieves the customer's past transaction records and determines the customer's loyalty level 520, 530 or 540.

As an example, there may be two different loyalty levels, level I 520 and level II 530. At the same time, some customers may not have joined the loyalty club; thus, do not belong to any loyalty level 540. If the evaluation system determines that the customer does not belong to any one of the loyalty programs 540, the media specification control may determine that a “join the club media” file 541 should be displayed to the customer. After the “join the club media file” 541 has been displayed to the customer, other promotional media files 560 may then be determined to be displayed to the customer.

Alternatively, some customers may belong to level I loyalty group 520. Within the level I loyalty program 520, there may still be different classes of loyalty members (e.g., unregistered loyalty members 521 and registered loyalty members 522). Unregistered loyalty members may be the members that only obtained a loyalty card, but have not provided the personal information required to become a registered member. For the unregistered customers, the media specification control may determine that a “please register media” file 523 should be displayed. For the registered customers, the media specification control may determine that an “upgrade to level II media” file 524 should be displayed.

Similarly, some customers may belong to level II loyalty group 530. Within level II loyalty program 530, there may also be different classes of loyalty members. For example, some customers may qualify for a standard discount, and some customers may qualify for a price match discount. For the customers that only qualify for the standard discount, the media specification control may determine that the “standard discount media” file 531 should be displayed. For the customers that qualify for the price match discount, the media specification control may determine that one of the “price match discount” media files 532-534 should be displayed. The ellipsis 534 represents that there may be any number of “price match discount media” files that may be displayed to the customer.

One or more of the multiple media files 532 and 533 may be randomly selected to be displayed to the qualified customers. Alternatively, a predetermined sequence and/or algorithm may be used to control which media file is to be displayed. The purpose of such a predetermined sequence and/or algorithm is to avoid inter-repeat (i.e., displaying the same media file to the same customer repeatedly). For example, one day, a customer has visited the gas station, and during the visit, the price match discount 1 media file 532 was displayed to the customer. If the customer visits the gas station again a few days later, the media specification control may determine that the price match discount 2 media 533 (instead of the media 532) will be displayed to the customer.

Further, after the promotional media related to different levels' loyalty membership is displayed, the media specification control may further determine a next media file to be displayed. For example, for the loyalty member customers, the media specification control may further display media files that are related to other additional benefits available on the customer's loyalty account. For the non-loyalty member customers, the media specification control may not have enough information to generate targeted media files. Thus, any one of the other promotional media files 560 may be displayed.

FIG. 5B further illustrates an example embodiment 500B of media specification control that is configured to dynamically determine media files that are related to benefits available on the customer's loyalty account. A sequence of media files may be displayed to qualified customers. Circle 551 represents that the POS system may determine whether the customer qualifies for any freebie based on the customer evaluation data. Alternatively, the customer evaluation data may include information related to whether the customer qualifies for any freebies.

If the customer qualifies for a freebie including any one of a hot/cold drink, a particular brand item, and an energy drink, a series of media files 551-A through 551-C may be displayed to the customer sequentially. As illustrated in FIG. 5B, the “hot/cold drink freebie media” file 551-A may first be displayed. Thereafter, the “particular brand freebie media” file 551-B and the “energy drink freebie media” file 551-C may then be displayed.

In some embodiments, if the customer has frequently purchased hot or cold drinks in the past, the “hot/cold drink freebie media” file 551-A may first be displayed to the customer, and other freebie media files 551-B and 551-C may then be displayed. Alternatively, if the customer has frequently purchased energy drinks in the past, the “energy drink freebie media” file 551-C may first be displayed to the customer, and the other freebie media files 551-A and 551-B may then be displayed.

Further, the evaluation data may also include the customer's reward points information. The points information may be received from an external evaluation system. If the customer's reward points are greater than 500, the media specification control may determine that a “>500 points media” file 552-A should be displayed to the customer; similarly, if the customer's reward points are greater than 450 (but less than 500), the media specification control may determine that a “>450 points media” file 552-B should be displayed to the customer.

If the customer does not qualify for any freebie, but very close to qualify for a freebie, the POS system may determine that the customer is in a “1-away from freebie” status 553. For the customers that are in the 1-away from freebie status 553, the media specification control may determine that a number of 1-away freebie media files 553-A through 553-C should be displayed to the customer sequentially. The sequence of the freebie media files 553-A through 553-C may also be determined based on the customer's past purchase history.

If the customer does not qualify or is far from qualifying for a freebie, or there is additional time left after all the media related to freebies and points have been displayed, other promotional media files 560 may then be displayed to the customer. The other promotional media files 560 may be media files that are not specifically directed to the customer. Thus, the sequence of displaying other promotional media files 560 are less important. However, customers do not enjoy watching the same media repeatedly. Thus, various inter-repeat avoidance algorithms may be implemented to try to avoid repeatedly displaying the same media files to the same customer at two consecutive visits of an affiliated gas station.

FIG. 5C illustrates an embodiment of displaying the other promotional media files 560 based on a predetermined sequence based on the day of the week to avoid inter-repeat. For example, on Sundays 560-A, the promo 0 media file 561 will be displayed first, and then the promo 1 media file 562 will be displayed, and so on. As another example, on Mondays 560-B, the promo 1 media file 562 will be displayed first, and then the promo 2 media file 563 will be displayed, and so on. After the promo 6 media file 567 is displayed, promo 0 media file 561 will then be displayed. Depending on how much time it takes a customer to complete a fuel transaction, a different number of media files may be displayed. As such, the Sunday customers will at least view the promo 0 file 561; the Monday customers will at least view the promo 1 file 562, and so on. Assuming a customer will randomly visit a gas station. Thus, on each day, the chance for the same customer to visit the gas station is the same, and the customer will have an equal chance to view each of the promotional medias 561 through 567.

However, certain customers may prefer to visit the gas station on a specific day of the week. For example, a particular customer may prefer to go to a gas station on each Monday; the embodiment of FIG. 5C would cause the customer to review the same promo media files every week. This problem may be solved by the embodiment illustrated with respect to FIG. 5D.

FIG. 5D illustrates an embodiment of displaying the other promotional media files 560 randomly to avoid inter-repeat. Referring to FIG. 5D, the promotional media files 561 through 565 are sent to a randomizer to generate a random set of media files 580. As illustrated in FIG. 5D, the random set of media files 580 includes promo media A file 581 and promo media B file 582, each of which is a media file included in the promotional media files 561 through 565. The ellipsis 583 represents that there may be any number of promotional media files in the random set of media files 580. Using the randomizer 570 to generate random sets of media files would solve the above problem presented in the embodiment of FIG. 5C.

FIG. 5E further illustrates an example table 500E that may be implemented at a media specification control to control what promotional media files are to be displayed to each customer. The table 500E includes a rule column 591, a description column 592, an active column 593, an effective date column 594, a media column 595, a default column 596, and multiple day columns 597. Each of the multiple day columns 597 represents a day of the week (e.g., Sunday, Monday, Tuesday, etc.).

The rule column 591 may be used to identify each rule. The description column 592 may include the descriptions of the corresponding rules. The active column 593 may use a Boolean number 1 or 0 to define whether the rule is still active. The effective date column 594 may include the effective dates of the corresponding rules. The media column 595 may specify whether a media file or a default text message is to be displayed. For example, there may be situations that only a text message is to be displayed. In such a case, the corresponding media file column 595 will have Boolean value 0. If a media file is to be displayed, the corresponding media file column 595 will have Boolean value 1. The default column 596 may be used to specify whether the rule allows a default sequence. In the columns corresponding to days, a number of media files are listed in it. These media files may be displayed in the default sequence, a specific sequence, or randomly.

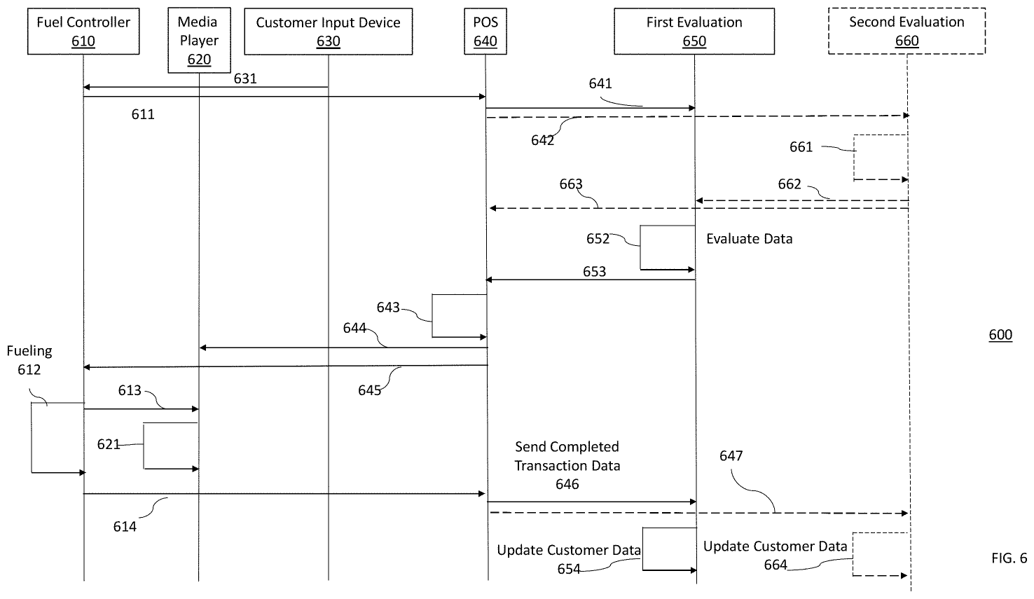

FIG. 6 illustrates a diagram of example communications that may occur amongst different devices during a customer transaction at a fuel dispenser. As illustrated in FIG. 6, the different devices may include a fuel controller 610, a media player 620, a customer input device 630, a POS system 640, a first evaluation system 650, a second evaluation system 660. The vertical lines represent a time sequence in which the communications may occur. However, in general, the communications are not required to occur in the sequence illustrated in FIG. 6, unless one communication is dependent on another communication being completed prior to the communication being performed.

As described above with respect to FIG. 2, when a customer visits a gas station, the customer often uses the customer input device 630 (e.g., swipe a credit card or membership card) to input the customer's data. The customer input device 630 may send the customer's input data to the fuel controller 610, which is represented by arrow 631. The fuel controller 610 may then pass on the customer's input data to the POS system 640, which is represented by arrow 611.

The POS system 640 may then send at least a portion of the customer input data to the first evaluation system 650, which is represented by arrow 641. The first evaluation system 650 may retrieve the corresponding customer's evaluation data (herein after referred to as a first set of customer evaluation data) base on the received customer input data, which is represented by arrow 652. The retrieved first set of customer evaluation data may be sent to the POS system 640, which is presented by arrow 653.

In some embodiments, the POS system 640 may also have access to a second evaluation system 660. Thus, the POS system 640 may also send at least a portion of the customer input data to the second evaluation system 660, which is represented by the dotted arrow 642. Similarly, the second evaluation system 660 may retrieve the corresponding customer's evaluation data (hereinafter referred to as a second set of evaluation data) based on the received customer input data, which is represented by dotted arrow 661.

In some embodiments, the retrieved second set of customer evaluation data may be sent to the POS system 640 directly, which is represented by the dotted arrow 663. In some embodiments, the retrieved second set of customer evaluation data may be sent to the first evaluation system 650, which is represented by the dotted arrow 662. In such a case, the first evaluation system 650 may further evaluate the second set of evaluation data with its own customer data to generate the first set of evaluation data.

The POS system 640 receives the first set and second set of evaluation data from the first evaluation system 650 and the second evaluation system 660, and based on the received two sets of evaluation data to determine a specific set of media, which is represented by the arrow 643. The determined media set is then sent to the media player 620, which is presented by arrow 644.

At any point of time during this process, the POS system 640 may also send a signal to the fuel controller 610 to cause the fuel controller 610 to allow the customer to pump fuel at the corresponding fuel dispenser, which is represented by the arrow 645. Once the fuel controller 610 turns the control of the corresponding fuel dispenser on, the customer may start fueling, which is represented by the arrow 612.

Once the fuel controller 610 turns the control of the corresponding fuel dispenser on, the fuel controller 610 may also send a media start signal to the media player 620, which is represented by the arrow 612. The start signal received from the fuel controller 610 may cause the media player 620 to start playing the specific media files received from the POS system 640, which is represented by the arrow 621.

After the customer finishes the fuel transaction, the fuel controller may turn the pump off, and send information related to the completed fuel transaction to the POS system 640, which is represented by the arrow 613. The POS system 640 may then send the complete customer transaction information to each of the first evaluation system 650 and the second evaluation system 660, which is represented by the arrows 646 and 647. Thereafter, each of the first evaluation systems 650 and 660 may update its customer database to include the newly completed transaction and update the corresponding customer's evaluation data, which is represented by the arrows 654 and 664.

In some embodiments, the first evaluation system 650 may correspond to the internal evaluation system 213 of FIG. 2, and the second evaluation system 660 may correspond to the external evaluation system 212 of FIG. 2. In some embodiments, as described above, it is not necessary that there are always an internal evaluation system 213 and an external evaluation system 212 that interact with the POS system 640. The dotted lines in FIG. 6 represent that in some embodiments, there may only be one evaluation system (e.g., an internal evaluation system 212 or an external system 213) interacting with the POS system. Alternatively, in some embodiments, there may more than two evaluation systems interacting with the POS system, as illustrated in FIG. 4.

The following discussion now refers to a method and method acts that may be performed. Although the method acts may be discussed in a certain order or illustrated in a flow chart as occurring in a particular order, no particular ordering is required unless specifically stated, or required because an act is dependent on another act being completed prior to the act being performed.

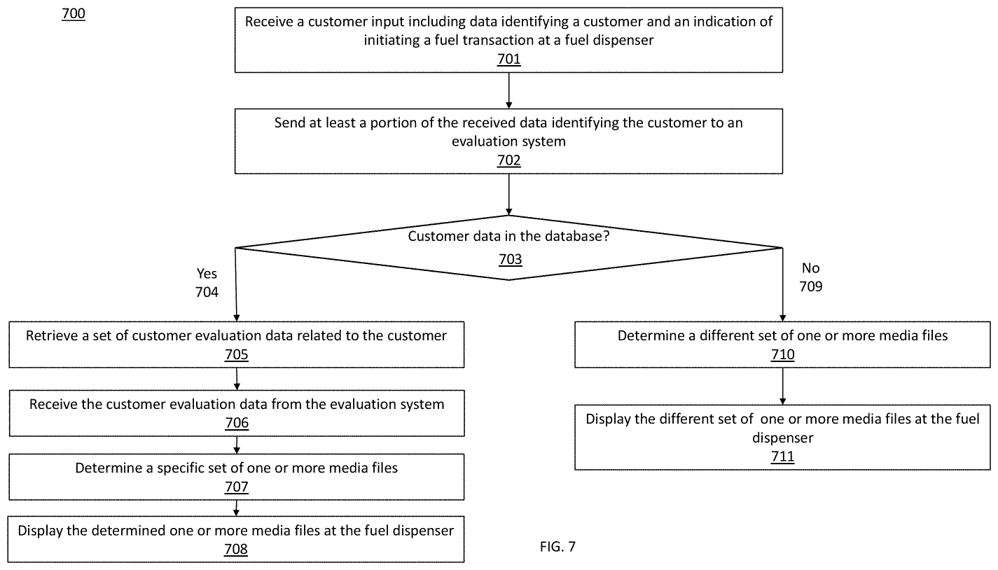

FIG. 7 illustrates a flow chart of example method 700 for dynamically displaying media files based on customer input. Method 700 includes receiving a customer input, including data identifying a customer and an indication of initiating a fuel transaction at a fuel dispenser (act 701). For example, the customer input may be received from a customer input device 203 of FIG. 2. The method also includes sending at least a portion of the received data identifying the customer to an evaluation system (act 702). The evaluation system is associated with a database that contains data related to multiple customers. The evaluation system is also configured to evaluate the data related to multiple customers to generate customer evaluation data. The evaluation system may correspond to the internal evaluation system 213 or the external evaluation system 212 of FIG. 2.

Further, the evaluation system is then caused to determine whether any data related to the customer is contained in the database based on the data identifying the customer (act 703). In response to a determination that a set of data related to the customer is contained in the database (704), the evaluation system is caused to retrieve a set of customer evaluation data related to the customer (act 705). The set of customer evaluation data is then received from the evaluation system (act 706).

Based on the received set of customer evaluation data, a specific set of one or more media files that are to be displayed for the customer is then determined (act 707). The determination of the specific set of one or more media files may be performed by a media specification control, which may correspond to the media specification control 330 of FIG. 3 and/or 430, 440 of FIG. 4. Finally, the determined specific set of one or more media files are caused to be displayed at the fuel dispenser (act 708), which may be performed by a sequence control that may correspond to the sequence control 350 of FIG. 3 and/or 480 of FIG. 4.

On the other hand, in response to a determination that no data related to the customer is contained in the database (709), a different set of one or more media files may be determined (act 710). Thereafter, the different set of one or more media files may then be caused to be displayed at the fuel dispenser (act 711). The different set of one or more media files may correspond to the other promotional media files 560 of FIGS. 5A through 5D. In some embodiments, the different set of one or more media files be displayed based on a predetermined sequence, as illustrated in FIG. 5C. Alternatively, the different set of one or more media files may be displayed randomly as illustrated in FIG. 5D.

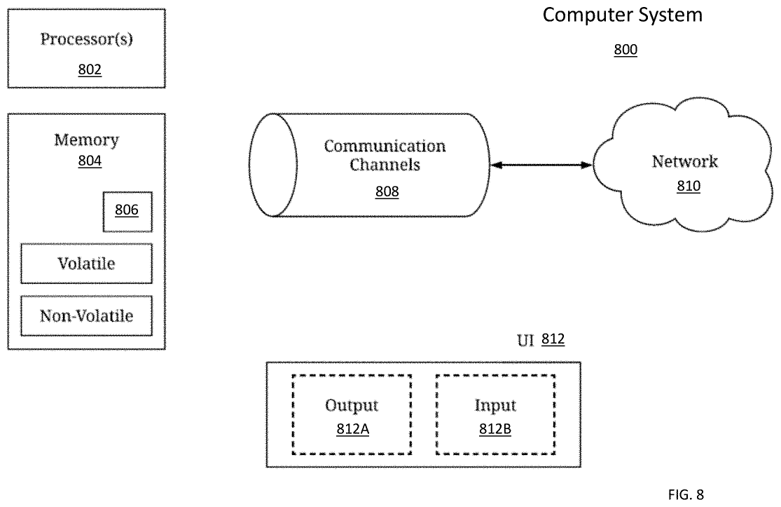

Finally, since the POS system 210 of FIG. 2 and 640 of FIG. 6 may be a computer system 110 of FIGS. 1a and 1b, some introductory discussion of a computer system will be described with respect to FIG. 8. FIG. 8 illustrates an exemplary computer system consistent with the implementation of a computer system 110, illustrated in FIG. 1a and FIG. 1b.

Computer systems are now increasingly taking a wide variety of forms. Computer systems include, for example, handheld devices, appliances, laptop computers, desktop computers, mainframes, distributed computer systems, or even devices that have not conventionally been considered as a computer system. In this description and the claims, the term “computer system” is defined broadly as including any device or system (or a combination thereof) that includes at least one processor and a memory capable of having thereon computer-executable instructions that may be executed by the processor. The memory takes any form and may depend on the nature and form of the computer system. In some embodiments, a computer system is distributed over a network environment and includes multiple constituent computer systems.

As illustrated in FIG. 8, in its most basic configuration, a computer system 800 typically includes at least one processing unit 802 and memory 804. In some embodiments, the memory 804 is a physical system memory that includes volatile memory, non-volatile memory, or some combination of the two. The term “memory” is also used herein to refer to non-volatile mass storage such as physical storage media. If the computer system is distributed, the processing, memory and/or storage capability may be distributed as well. As used herein, the term “module” or “component” can refer to software objects or routines that execute on the computer system. The different components, modules, engines, and services described herein may be implemented as objects or processes that execute on the computer system (e.g., as separate threads).

Embodiments are described within this specification with reference to steps or acts that are performed by one or more computer systems, such as computer system 110. If such acts are implemented in software, one or more processors of the associated computer system that performs the act direct the operation of the computer system in response to having executed computer-executable instructions. An example of such an operation involves the manipulation of data. The computer-executable instructions (and the manipulated data) may be stored in the memory 804 of the computer system 800.

Part of the acts directed by the processing unit(s) 802 may be to display certain information on a display 806. The display 806 is illustrated as being a particular form in FIG. 8. However, the nature and size of the display 806 may differ depending on the physical form of the computer system 800. Since the computer system 800 may take on a wide variety of physical forms, the display 806 may also have a wide variety of physical forms.

Computer system 800 may also contain communication channels 808 that allow the computer system 800 to communicate with other message processors over, for example, network 810. Communication channels 808 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Computer system 800 may also communicate with output module 812A and input module 812B such as by way of user interface module 812.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general-purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system for dynamically displaying media files at a fuel dispenser based on customer input, the system comprising:
one or more processors; and
one or more computer-readable media having stored thereon executable instructions that when executed by the one or more processors configure the computer system to perform at least the following:
receive a customer input including at least data identifying a customer and an indication of initiating a fuel transaction at a fuel dispenser;
send at least a portion of the received data identifying the customer to an evaluation system, the evaluation system being associated with a database containing data related to a plurality of customers and configured to evaluate the data related to the plurality of customers to generate customer evaluation data;
cause the evaluation system to determine whether any data related to the customer is contained in the database based on the data identifying the customer;
in response to a determination that a set of data related to the customer is contained in the database,
cause the evaluation system to retrieve a set of customer evaluation data related to the customer;
receive the set of customer evaluation data from the evaluation system;
based on the received set of customer evaluation data, determine a specific set of one or more media files that are to be displayed for the customer; and
cause the determined specific set of one or more media files to be displayed at the fuel dispenser.

2. The computer system of claim 1, wherein the specific set of one or more media files are selected from a predetermined plurality of media files.

3. The computer system of claim 1, the computer system being further configured to:
in response to a determination that no data related to the customer is contained in the database,
determine a different set of one or more media files that are to be displayed to the customer; and
cause the determined different set of one or more media files to be displayed at the fuel dispenser.

4. The computer system of claim 3, wherein the different set of one or more media files is a set of randomly selected one or more media files.

5. The computer system of claim 1, the computer system being further configured to:
when the specific set of one or more media files includes a plurality of media files, determine a sequence of the plurality of media files that are to be displayed; and
cause the plurality of media files to be displayed at the fuel dispenser in the determined sequence.

6. The computer system of claim 1, the computer system is further configured to perform:
receive an indication from a fuel controller that the fuel dispensing transaction is completed, the fuel controller configured to control a plurality of fuel dispensers including the fuel dispenser that the customer is currently at;
send information related to the completed fuel dispensing transaction to the evaluation system; and
cause the evaluation system to update the database based on the information related to the completed fuel dispensing transaction and generate an updated set of evaluation data related to the customer.

7. The computer system of claim 1, the computer system being further configured to:
send at least a portion of the data identifying the customer to another evaluation system, the other evaluation system being associated with another database containing data related to a plurality of customers and configured to evaluate data related to the plurality of customers to generate other customer evaluation data;
cause the other evaluation system to determine whether any data related to the customer is contained in the other database based on the data identifying the customer;
in response to a determination that another set of data related to the customer is contained in the other database,
cause the other evaluation system to retrieve a set of other customer evaluation data related to the customer;
receive the set of other customer evaluation data from the other evaluation system;
based on the received set of other customer evaluation data, determine another specific set of one or more media files that are to be displayed for the customer; and
cause the determined other specific set of one or more media files to be displayed at the fuel dispenser.

8. The computer system of claim 1, the computer system being further configured to:
send at least a portion of the data identifying the customer to another evaluation system, the other evaluation system being associated with another database containing data related to a plurality of customers and configured to evaluate data related to the plurality of customers to generate other customer evaluation data;
cause the other evaluation system to determine whether any data related to the customer is contained in the other database based on the data identifying the customer;
in response to a determination that another set of data related to the customer is contained in the other database,
cause the other evaluation system to retrieve a set of other customer evaluation data related to the customer;
receive the set of other customer evaluation data from the other evaluation system;
send the set of other customer evaluation data to the evaluation system;
cause the evaluation system to further evaluate the set of other customer evaluation data with the set of data contained in the database to generate the set of evaluation data.

9. The computer system of claim 7, the computer system being further configured to:
determine a sequence of the specific set and the other specific set of media files that are to be displayed; and
cause the specific set and the other specific set of media files to be displayed in the determined sequence.

10. The computer system of claim 7, the computer system is further configured to perform:
receive an indication from the fuel controller that the fuel dispensing transaction is completed; and
cause each of the evaluation system and the other evaluation system to update the respective database based on the information related to the completed fuel dispensing transaction and generate a respective updated set of evaluation data related to the customer.

11. The computer system of claim 1, wherein the evaluation system is remote to the computer system and is accessible by the computer system via a global network.

12. The computer system of claim 1, wherein the customer input includes data identifying the customer's membership, and
the database includes each of the plurality of customers' membership information, and
for each customer, the customer evaluation data includes at least a classification of the corresponding customer's membership or a point earned by the corresponding customer at least based on the corresponding customer's past completed fuel transactions.

13. The computer system of claim 1, wherein the customer input includes credit card information,
when the credit card is approved, the displaying of the specific set of one or more media files is caused to start by the computer system.

14. The computer system of claim 1, wherein the displaying of the specific set of one or more media files is caused to start by a fuel controller that is configured to control the fuel dispenser.

15. The computer system of claim 1, wherein the displaying of the specific set of one or more media files is caused to start when the customer starts pumping at the fuel dispenser.

16. The computer system of claim 1, wherein the displaying of the specific set of one or more media files is caused to start by an indication input by the customer.

17. A method for dynamically displaying media files at a fuel dispenser based on customer input, the method comprising:
receiving a customer input including at least data identifying a customer and an indication of initiating a fuel transaction at a fuel dispenser;
sending at least a portion of the data identifying the customer to an evaluation system, the evaluation system being associated with a database containing data related to a plurality of customers;
causing the evaluation system to determine whether any data related to the customer is contained in the database based on the received data identifying the customer;
in response to a determination that a set of data related to the customer is contained in the database,
causing the set of data to be evaluated to generate a set of customer evaluation data;
receiving the set of customer evaluation data from the evaluation system;
based on the received set of customer evaluation data, determining a specific set of one or more media files that are to be displayed for the customer; and
causing the determined specific set of one or more media files to be displayed at the fuel dispenser.

18. The method of claim 17, the method further comprising:
in response to a determination that no data related to the customer is contained in the database,
determining a different set of one or more media files that are to be displayed to the customer; and
causing the determined different set of one or more media files to be displayed at the fuel dispenser.

19. The method of claim 17, the method further comprising:
sending at least a portion of the data identifying the customer to another evaluation system, the other evaluation system being associated with another database containing data related to a plurality of customers;
causing the other evaluation system to determine whether any data related to the customer is contained in the other database based on the received data identifying the customer;
in response to a determination that another set of data related to the customer is contained in the other database,
causing the other set of data to be evaluated to generate another set of customer evaluation data;
receiving the other set of customer evaluation data from the other evaluation system;
based on the received other set of customer evaluation data, determining another specific set of one or more media files that are to be displayed for the customer; and
causing the determined other specific set of one or more media files to be displayed at the fuel dispenser.

20. A computer program product comprising one or more hardware storage devices having stored thereon computer-executable instructions that are executable by one or more processors of a computer system to configure the computer system to establish a secure connection between computer systems, the computer-executable instructions including instructions that are executable to configure the computer system to perform at least the following to cause a display at the fuel dispenser to dynamically display media files based on customer input:
receive a customer input including at least data identifying a customer and an indication of initiating a fuel transaction at a fuel dispenser;
send at least a portion of the data identifying the customer to an evaluation system, the evaluation system being associated with a database containing data related to a plurality of customers;
cause the evaluation system to determine whether any data related to the customer is contained in the database based on the received data identifying the customer;
in response to a determination that a set of data related to the customer is contained in the database,
cause the set of data to be evaluated to generate a set of customer evaluation data;
receive the set of customer evaluation data from the evaluation system;
based on the received set of customer evaluation data, determine a specific set of one or more media files that are to be displayed for the customer; and
cause the determined specific set of one or more media files to be displayed at the fuel dispenser.
